(19) United States
(12) Patent Application Publication
(10) Pub. No.: US 2010/0083508 A1
(43) Pub. Date: Apr. 8, 2010

(54) MANUALLY-OPERATED HAIR CLIPPER

(75) Inventor: Rocky Cheng, Taipo, N.T., Hong Kong SAR (HK)

Correspondence Address: SCULLY SCOTT MURPHY & PRESSER, PC, 400 GARDEN CITY PLAZA, SUITE 300, GARDEN CITY, NY, 11530, US

(73) Assignee: PERFECT STEAM APPLIANCES LTD., Fo Tan, Shatin, N.T. (HK)

(21) Appl. No.: 12/527,545

(22) PCT Filed: Feb. 6, 2008
(86) PCT No.: PCT/IB08/00388

§ 371 Date: Aug. 17, 2009

(30) Foreign Application Priority Data
Feb. 16, 2007 (IT) MI2007A000304

(51) Int. Cl. B26B 19/38

(52) U.S. Cl. 30/201; 30/233.5

(57) ABSTRACT

A manually-operated hair clipper, comprising a substantially elongated enclosure, which defines at one end a handle and is provided, at the opposite end, with a working head, which comprises a body for supporting a cutting blade assembly and a motor assembly, elements being provided for transmitting motion from the motor assembly to the cutting blade assembly, at least one comb element, which is associated with the supporting body so that it can slide along a direction for approach and spacing with respect to the cutting blade assembly in order to adjust the cutting length, and at least first teeth for stopping the comb element with respect to the supporting body.

### TECHNICAL FIELD

The present invention relates to a manually-operated hair clipper.

### BACKGROUND ART

Manually-operated hair clippers are known which comprise an elongated containment body, at one end of which there are two superimposed blades: a fixed one and one which can move with a reciprocating rectilinear motion along the first one.

The movable blade receives its motion from a motor which is accommodated within the containment body.

A grip handle is defined at the end of the containment body that lies opposite the two blades.

A comb is arranged at the blades and determines the length of the cut to be made.

These known hair clippers, however, suffer drawbacks, among which the fact that they cannot be used directly by the person whose hair is to be cut and require the intervention of an external operator, and therefore their use is limited only to hair styling centers and barbers and is not widespread on a personal and household level.

Another drawback of known hair clippers consists in that they are awkward to grip and handle and make it difficult to perform hair cutting operations in the different regions of the head, since the operator has to resort to bending and twisting his hand in order to be able to orient the blades in the intended direction.

Another drawback of known hair clippers resides in that in order to modify the cutting length it is necessary to replace the comb with another one of different length, and it is therefore necessary to have a plurality of different combs available and to replace them with awkward fitting and removal operations.

### DISCLOSURE OF THE INVENTION

The aim of the present invention is to devise a manually-operated hair clipper which can be used directly and easily even by the person whose hair is to be cut without requiring the intervention of an external operator and therefore can be used even on a personal and household level.

Another object of the present invention is to devise a hair clipper which can be gripped and handled easily by users, be they the people whose hair is being cut or external operators.

Another object of the present invention is to provide a hair clipper which allows to cut simply and precisely the hair of any part of the head without having to assume awkward positions with one's hands.

Still another object of the present invention is to provide a hair clipper which allows to change the cutting length simply and quickly.

Within this aim, another object of the present invention is to achieve said aim and objects with a hair clipper which is simple, relatively easy to provide in practice, safe in use, effective in operation, and relatively low in cost.

This aim and these objects are all achieved by the present manually-operated hair clipper, characterized in that it comprises:
a substantially elongated enclosure, which defines at one end a handle and is provided, at the opposite end, with a working head, which comprises a body for supporting a cutting blade assembly and a motor assembly, means being provided for transmitting motion from the motor assembly to the cutting blade assembly,
at least one comb element, which is associated with the supporting body so that it can slide along a direction for approach and spacing with respect to the cutting blade assembly in order to adjust the cutting length, and
at least first means for stopping the comb element with respect to the supporting body.

In a preferred embodiment, the hair clipper according to the invention also comprises second means for stopping the comb element with respect to the supporting body.

In another preferred embodiment, at least one of the first stop means and second stop means is of the ratchet type adapted to allow sliding in both directions.

In another preferred embodiment, the working head is associated with the enclosure so that it can rotate about an axis of rotation, means for locking the working head in preset angular positions being provided.

### BRIEF DESCRIPTION OF THE DRAWINGS

Further characteristics and advantages of the present invention will become better apparent from the detailed description of a preferred but not exclusive embodiment of a manually-operated hair clipper according to the invention, illustrated by way of non-limiting example in the accompanying drawings, wherein:

FIG. 1 is a front view of a hair clipper according to the invention;

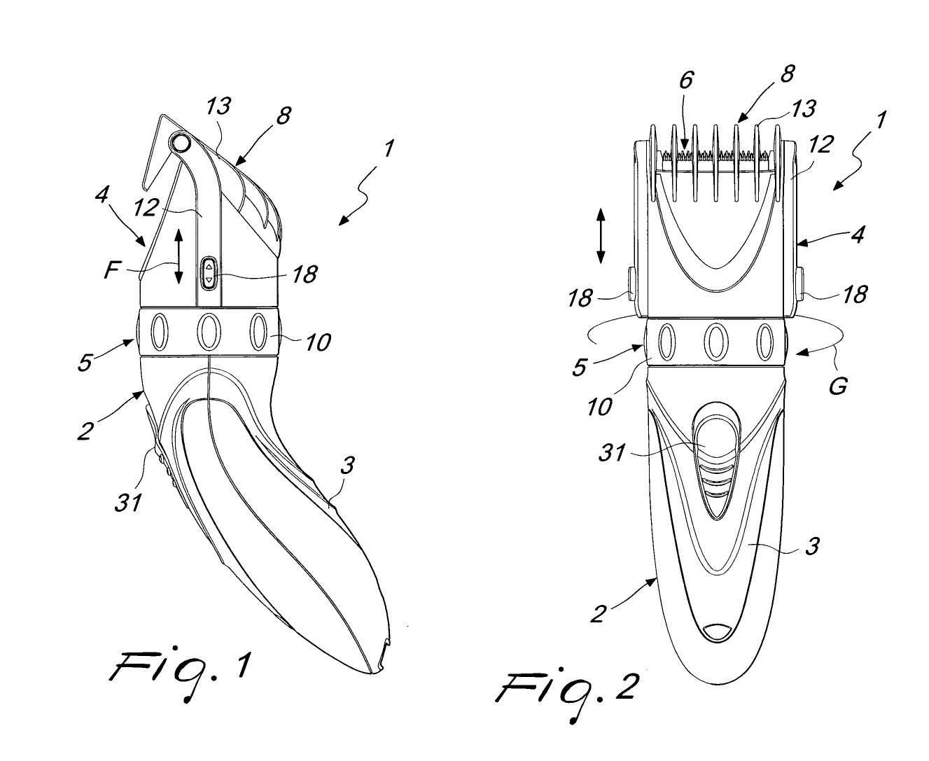

FIGS. 2 and 3 are side views of the hair clipper according to the invention;

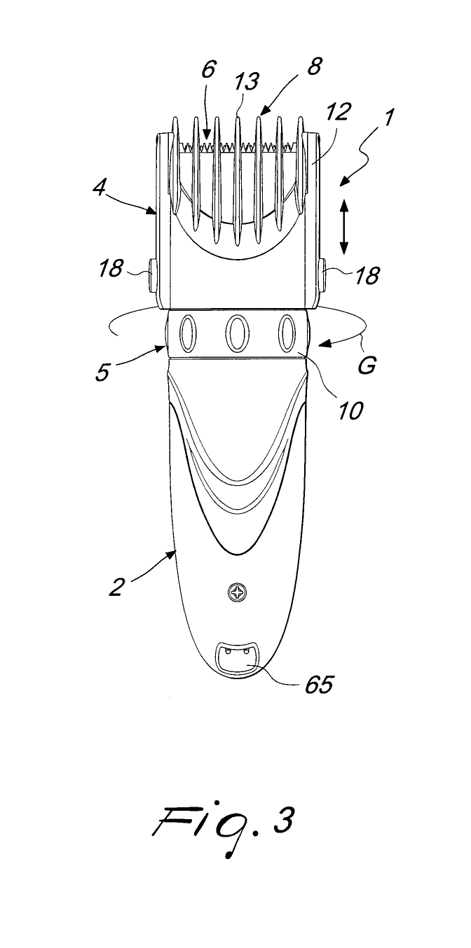

FIG. 4 is a partially sectional schematic view of a portion of the working head of the hair clipper according to the invention;

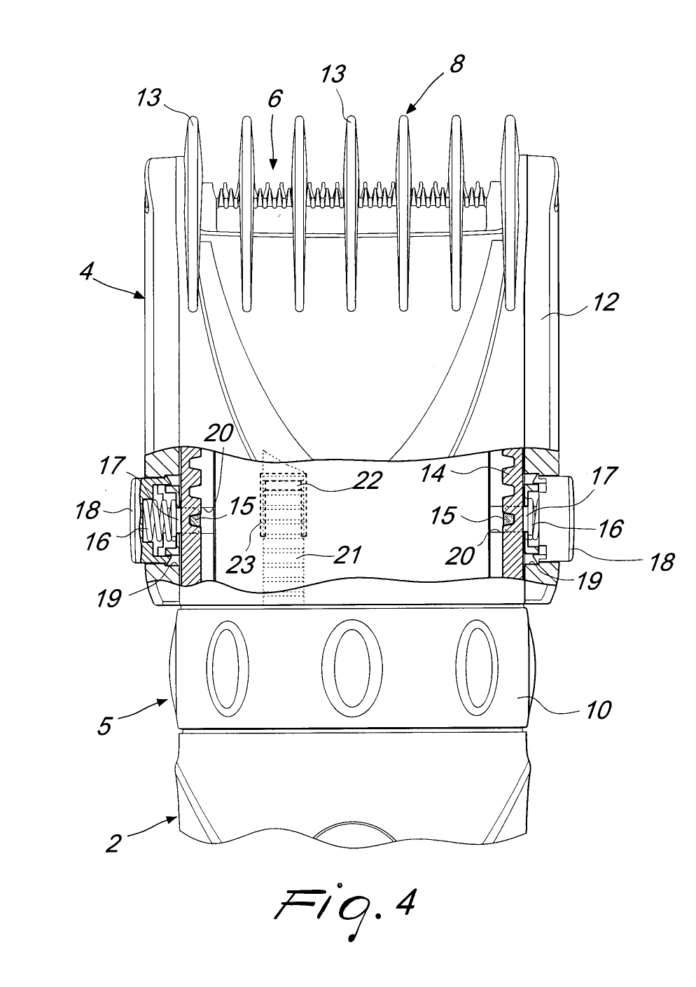

FIG. 5 is an exploded perspective view of the comb element of the hair clipper according to the invention;

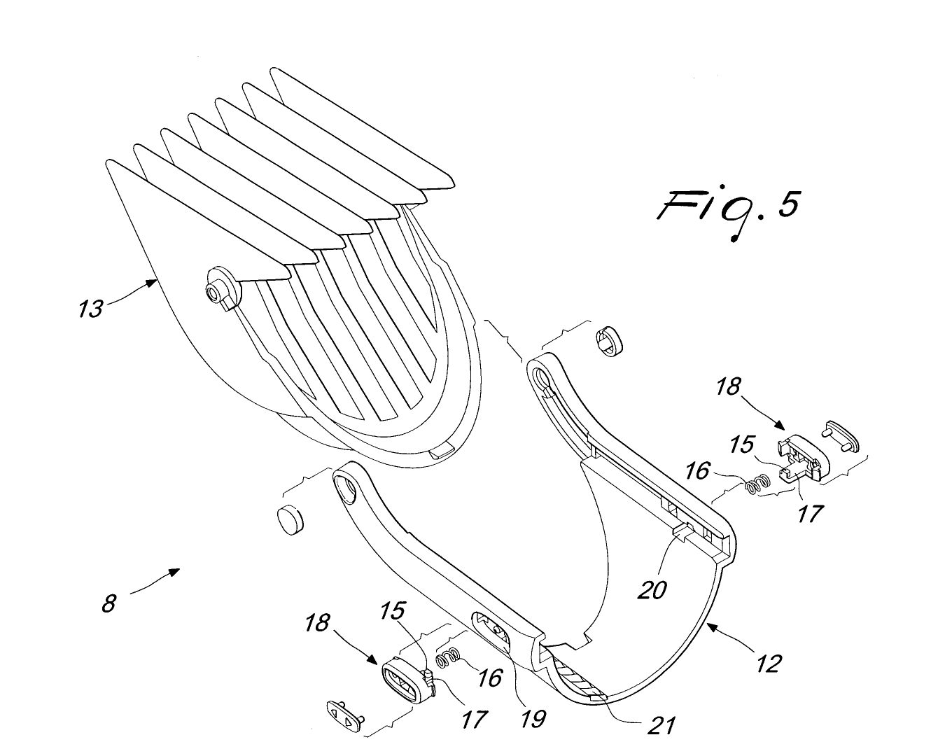

FIG. 6 is an exploded perspective view of the hair clipper according to the invention;

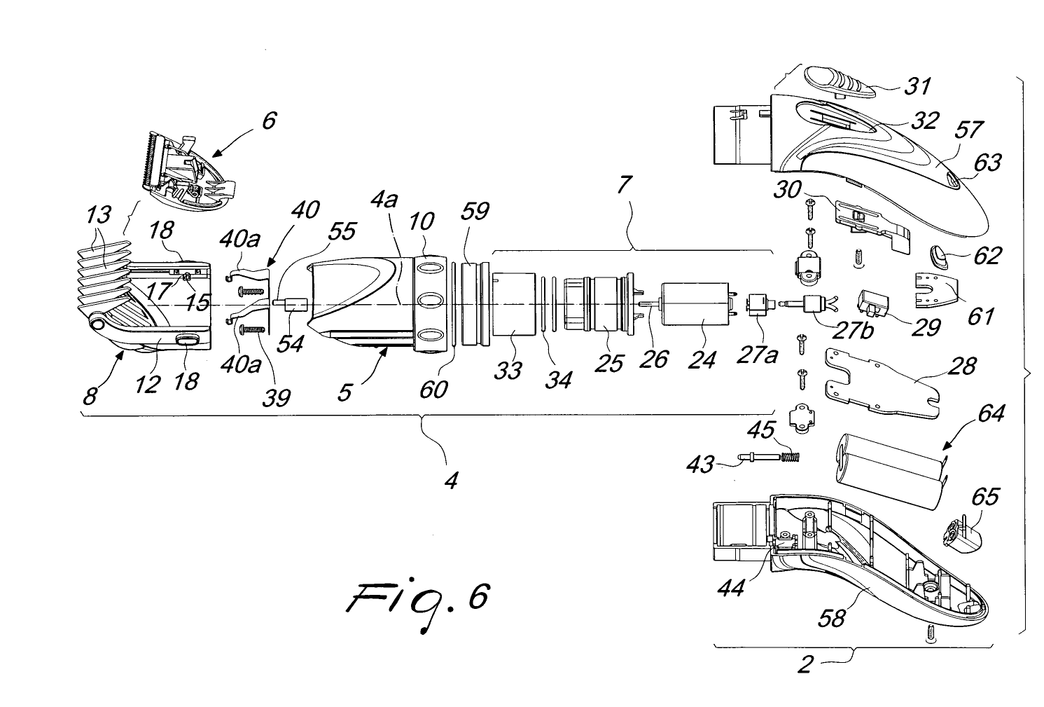

FIG. 7 is a schematic sectional view of the hair clipper according to the invention without the comb element;

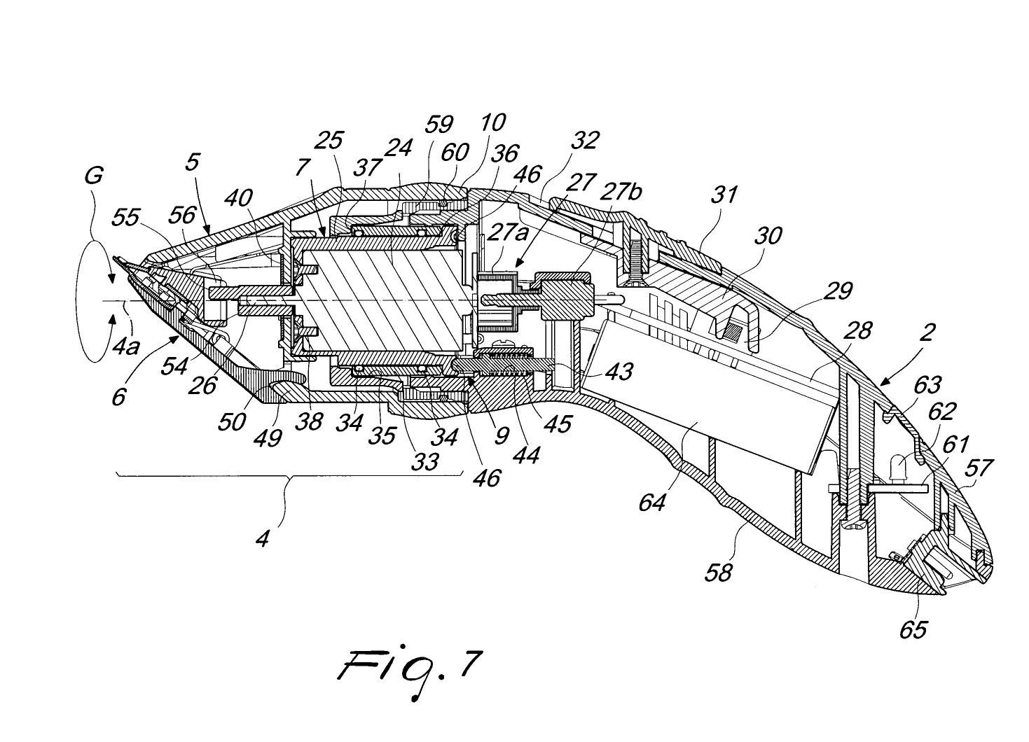

FIG. 8 is an exploded perspective view of the motor assembly of the hair clipper according to the invention;

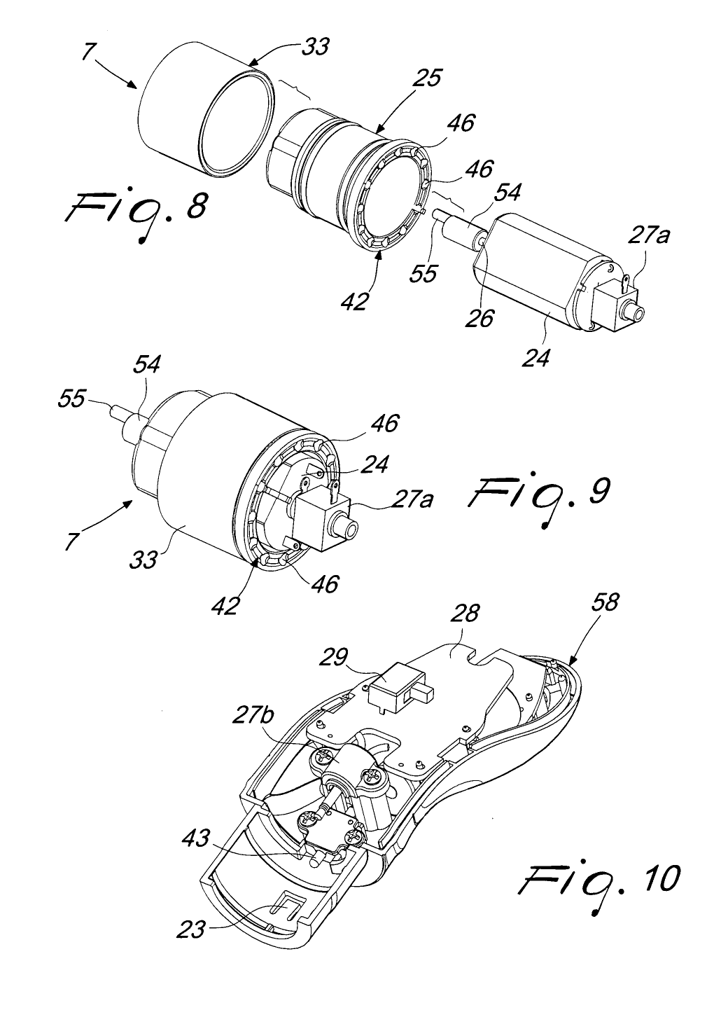

FIGS. 9-12 illustrate sequentially the steps of the assembly of the motor assembly and of the enclosure of the hair clipper according to the invention;

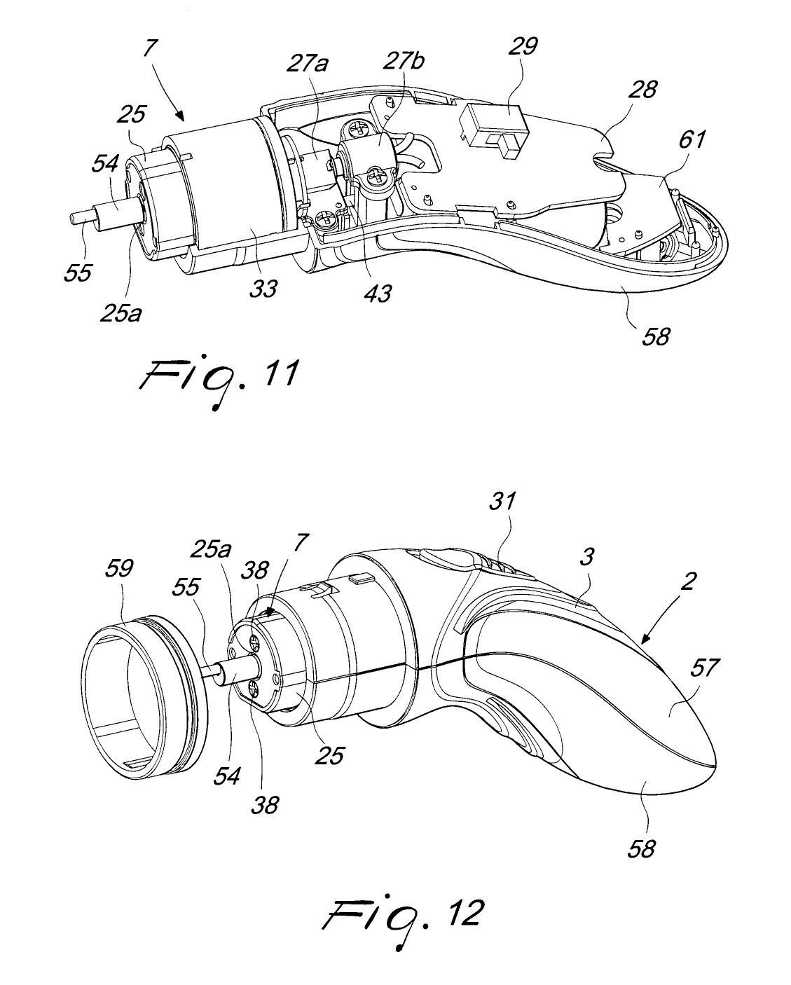

FIG. 13 is a view of the step of the assembly of the supporting body of the working head of the hair clipper according to the invention;

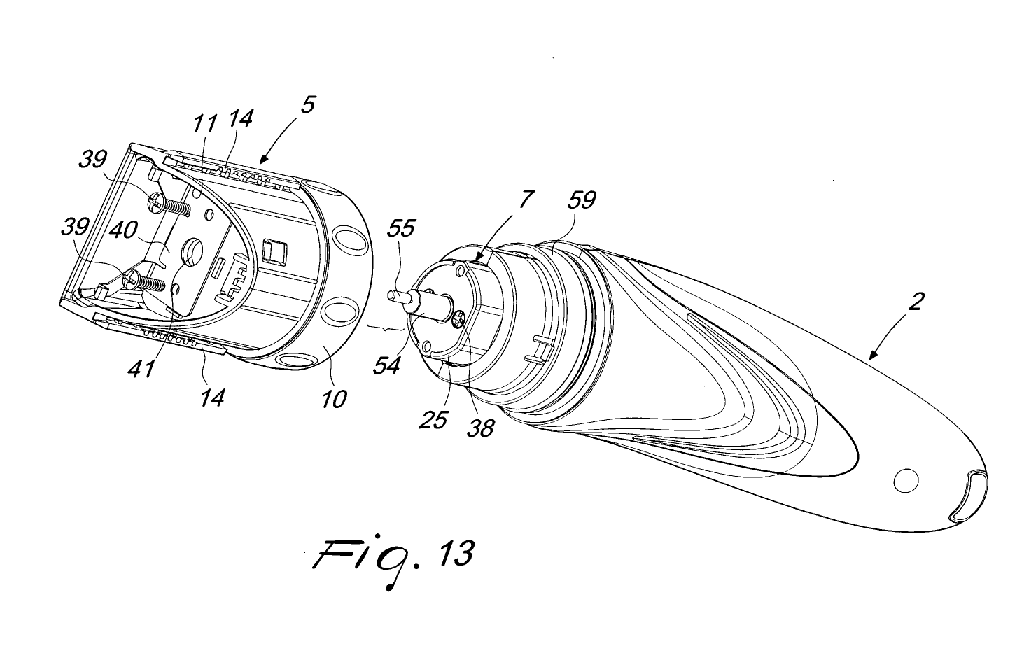

FIG. 14 is an exploded perspective view of the cutting blade assembly of the hair clipper according to the invention.

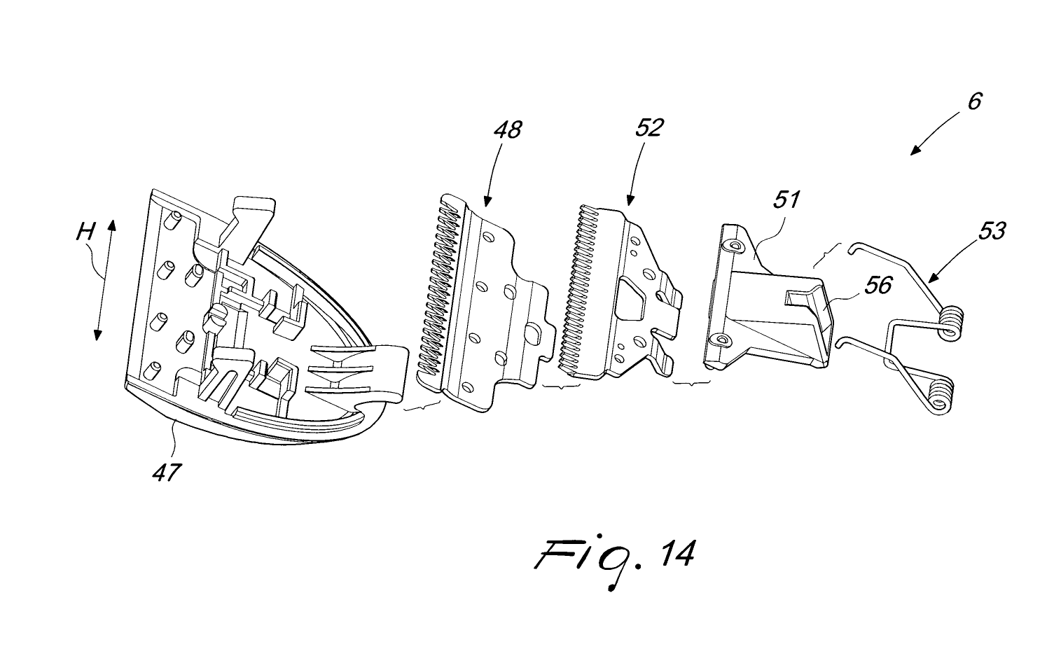

### WAYS OF CARRYING OUT THE INVENTION

With reference to the figures, the reference numeral 1 generally designates a manually-operated hair clipper.

The hair clipper 1 comprises a substantially elongated enclosure 2 which defines, at one end, a handle 3 and has, at the opposite end, a working head 4.

The working head 4 comprises a supporting body 5 for a cutting blade assembly 6 and a motor assembly 7; motion transmission means, detailed hereafter, are provided between the motor assembly 7 and the cutting blade assembly 6.

At least one comb element 8 is associated with the supporting body 5 so that it can slide along an approach and spacing path, indicated by the arrows F, with respect to the cutting blade assembly 6 to adjust the cutting length.

First and second stop means are provided between the comb element 8 and the supporting body 5 and are such as to lock temporarily the comb element 8 with respect to the supporting body 5 at a preset distance from the cutting blade assembly 6 as a function of the intended cutting length.

The working head 4 is associated with the enclosure 2 so that it can rotate, about a substantially longitudinal axis of rotation 4a, through a round angle in both directions of rotation, means 9 being provided for locking the working head 4 in predefined angular positions.

The working head 4 rotates about an axis 4a monolithically, i.e., the supporting body 5, the motor assembly 7 and the cutting blade assembly 6 rotate together about the axis 4a.

The supporting body 5 comprises a tubular portion which is open at the opposite ends; an annular collar 10 is defined at one end of the tubular portion and mates rotatably with the end of the enclosure 2; at the opposite end of the tubular portion there is a seat 11 for accommodating the cutting blade assembly 6.

The comb element 8 comprises a fork-like body 12 and a comb 13 which is articulated to the free ends of the two arms of the fork 12; the fork-like body 12 is coupled so that it can slide on the supporting body 5 in both directions along the path F.

The first means for stopping the sliding of the comb element 8 with respect to the supporting body 5 are of the ratchet type and comprise at least one first set of teeth 14, which is defined on the outer lateral surface of the supporting body 5 and extends parallel to the direction F, and at least one corresponding first stop tooth 15, which is associated with the comb element 8 so that it can move along a direction which is substantially perpendicular to the first set of teeth 14.

The first stop tooth 15 can move between an engagement configuration, in which it engages the first set of teeth 14 to lock the sliding of the comb element 8, and a release configuration, in which it disengages from the first set of teeth 14 to release the sliding of the comb element 8.

Elastic pusher means are further provided which are constituted by a spring 16 and act between the first stop tooth 15 and the comb element 8 and are adapted to keep the first stop tooth 15 in the engagement configuration, so as to lock the comb element 8.

In the illustrated embodiment, the first stop tooth 15 is defined at the end of a tab 17 which protrudes from a button 18 which is guided so that it can slide along a direction which is perpendicular to the first set of teeth 14 in a corresponding seat 19 formed in the fork-like body 12. The spring 16 is interposed between the base of the seat 19 and the button 18. The tab 17 is inserted slidingly in a straight guide 20 formed in the fork-like body 12.

The spring 16 keeps the button 18 in a configuration in which it is partially extracted from the seat 19, so that the first stop tooth 15 engages the first set of teeth 14.

By pressing the button 18 from outside in contrast with the action of the spring 16, a thrust is generated on the button 18 which is adapted to make it retract into the seat 19; in this manner, the first stop tooth 15 moves away temporarily from the first set of teeth 14, allowing the free sliding of the comb element 8.

Conveniently, the first stop means comprise two first sets of teeth 14 and corresponding opposite first stop teeth 15. The second means for stopping the sliding of the comb element 8 with respect to the supporting body 5 also are of the ratchet type and comprise at least one second set of teeth 21, which is defined on the inner lateral surface of the comb element 8, or rather of the fork-like body 12, and extends parallel to the path F, and at least one corresponding second stop tooth 22, which is associated with the supporting body 5 so that it can move between an engagement configuration and a disengagement configuration with respect to the second set of teeth 21, respectively to lock and release the sliding of the comb element 8 with respect to the supporting body 5.

Moreover, second elastic means are provided which keep the second stop tooth 22 in the engagement configuration.

In the illustrated embodiment, such second elastic means comprise an elastically flexible tab 23, which is accommodated in a corresponding opening defined in the supporting body 5; one of its ends is associated with one side of said opening and the opposite side is free and has the second stop tooth 22 which protrudes therefrom.

The tab 23 keeps the second stop tooth 22 in the configuration for engagement with the second set of teeth 21; by pushing or pulling the comb element 8 along the path F, the tab 23 flexes elastically, disengaging temporarily the second stop tooth 22 from the second set of teeth 21, thus allowing the sliding of said comb element.

Advantageously, the first sets of teeth 14 and the second set of teeth 21 are arranged so that their respective teeth match up and are mutually aligned.

The presence of the first stop means and of the second stop means provides a double system for locking the sliding of the comb element 8 with respect to the supporting body 5.

The motor assembly 7 comprises a motor 24 of the electric type, which is accommodated in a tubular support 25 and protrudes, at one end, with a motor shaft 26 and is associated, at the opposite end, with a connection 27 to an electric circuit which is printed on a board 28.

To open and close the electric circuit, there is a switch 29 controlled by a lever 30, which in turn is actuated by a button 31 associated with the enclosure 2 so that it can slide along a guide 32 provided within the enclosure 2.

The connection 27 comprises a socket 27a which is associated with the terminal circuit of the motor 24 and in which a pin 27b is inserted and is welded to the board 28.

The tubular support 25 is coupled with a rotary coupling to the end of the enclosure 2 and is rigidly associated with the supporting body 5; in this manner, the motor assembly 7 and the supporting body 5, with which the cutting blade assembly 6 and the comb element 8 are associated, rotate about the axis 4a, which is defined by the motor shaft 26, as a single body.

The rotary coupling defined between the tubular support 25 and the end of the enclosure 2 comprises a cylindrical bush 33, which surrounds externally the tubular support 25 with the interposition of a pair of sealing rings 34, and a corresponding receptacle 35 for the bush 33, which is defined at the end of the enclosure 2.

There are also means for connecting the bush 33 and/or the tubular support 25 to the receptacle 35, which are adapted to prevent the relative axial sliding of the bush 33 and/or of the tubular support 25 with respect to the receptacle 35. In the illustrated embodiment, such connection means comprise a first shoulder 36 defined within the tubular support 25 and a second shoulder 37 defined within the enclosure 2, the bush 33 being locked axially between such shoulders.

The motor 24 is fixed to the tubular support 25 by way of threaded connection means, which are constituted by first screws 38, which are provided at the base of the tubular support 25 which lies opposite the enclosure 2; in this same base a through hole 25a is provided from which the motor shaft 26 protrudes.

The supporting body 5 is fixed to the tubular support 25 by way of respective threaded connection means, which are constituted by second screws 39. The second screws 39 are used to anchor to the end of the supporting body 5 a bracket 40 for supporting the cutting blade assembly 6.

In the supporting body 5 there is also a through hole 41 from which the motor shaft 26 protrudes in order to mate with the cutting blade assembly 6.

The tubular support 25, to which the motor 24 and the supporting body 5 are anchored, is therefore rotationally coupled, by means of the bush 33 and the sealing rings 34, to the end of the enclosure 2 and can turn in both directions of rotation through a round angle, as indicated by the arrows G. This possibility of rotation allows to orient the working head 4 in any cutting direction.

In order to fix the working head 4 in a specific angular position, there are the locking means 9, which comprise a spring-loaded cam mechanism which is defined between the base of the tubular support 25 which is directed toward the enclosure 2 and the enclosure 2 itself.

This spring-loaded cam mechanism comprises a cylindrical cam 42, which is defined on the base of the tubular support 25 which is directed toward the enclosure 2 and is substantially concentric to the rotation axis 4a.

The end of a rod 43 slides along the cylindrical cam 42 and is associated inside the enclosure 2 so that it can slide with a reciprocating rectilinear motion along a direction which is parallel to the rotation axis 4a. The opposite end of the rod 43 is accommodated in a sliding guide 44 defined inside the enclosure 2.

Elastic pusher means are accommodated inside the sliding guide 44 and are constituted by a pusher spring 45, which keeps the rod 43 in contact with the cylindrical cam 42.

The cylindrical cam 42 defines a path for the sliding of the end of the rod 43 and along said cam one or more recesses 46 are provided for stopping the rod 43 and therefore for stopping the rotation of the tubular support 25 and of all of the working head 4.

The recesses 46 therefore constitute the means for locking the rotation of the working head 4 in specific angular positions; in a preferred embodiment, the recesses 46 are hemispherical and are twelve in number, arranged at π/3 rad with respect to each other; the working head 4 therefore assumes twelve corresponding angular positions.

However, a smaller or larger number of recesses 46 distributed with a different spacing may also be provided.

The cutting blade assembly 6 comprises a fixed support 47, which is accommodated in the seat 11 defined in the supporting body 5 and with which a fixed blade 48 is associated.

The fixed support 47 is anchored to the supporting body 5 by engagement with the arms 40a of the supporting bracket 40 and by the engagement of a lip 49, which is defined in the supporting body 5 with a corresponding cavity 50 defined in the fixed support 47.

A movable support 51 is guided with a reciprocating rectilinear motion along a cutting direction, indicated by the arrow H, on the fixed support 47.

A cutting blade 52 is fixed to the movable support 51.

The cutting blade 52 is kept pressed against the fixed blade 48 by presser means, which are constituted by a spring 53.

The fixed blade 48 and the cutting blade 52 which is superimposed thereon and parallel thereto are parallel to a plane which is inclined with respect to the longitudinal axis of the supporting body 5, i.e., with respect to the rotation axis 4a with the respective cutting profiles directed toward the outside of the working head 4.

The cutting profiles of the two blades are covered by the comb element 8 associated with the supporting body 5.

The movable support 51, which carries the cutting blade 52, is associated with the means for transmitting motion from the motor assembly 7 to the cutting blade assembly 6. Such transmission means comprise a wheel 54, which is keyed on the end of the motor shaft 26 that protrudes from the tubular support 25 and from the supporting body 5 and is provided with at least one eccentric pivot 55, which engages a slot 56 formed in the movable support 51.

The enclosure 2 is constituted by two half-shells 57 and 58, which are coupled by interlocking and are fixed by threaded connection means, which define at one end the handle 3 and the receptacle 35 of the bush 33 at the opposite end. At such end there is a locking ring 59 on which the annular collar 10 of the supporting body 5 is fitted so that it can rotate. A gasket 60 is provided between the annular collar 10 and the locking ring 59.

Conveniently, the two half-shells 57 and 58 are arc-shaped, so as to facilitate grip of the handle 3.

There is also a second printed circuit 61 for indication, associated with a luminous indicator 62 of the LED type, which is covered by a cap 63 anchored to the half-shell 57.

Finally, inside the enclosure 2 there are batteries 64 of the rechargeable type and there is a connection 65 to an external power supply which can be used to recharge the batteries 64 and to power the hair clipper 1 directly.

Operation of the hair clipper is as follows.

The user, by pressing the buttons 18 so as to move the first stop teeth 15 into a configuration for disengagement from the first sets of teeth 14, and by pulling or pushing on the comb element 8 so as to make it slide along the path F, adjusts the distance of the comb element 8 from the cutting blade assembly 6 and therefore the cutting length.

During the sliding of the comb element 8, the tab 23 flexes, disengaging the second stop tooth 22 from the second set of teeth 21.

By releasing the buttons 18, the first stop teeth are returned to the configuration for engagement with the respective first sets of teeth 14 by the springs 16.

The comb element 8 thus remains locked in position by way of the combined action of the first stop means (first sets of teeth 14 and first stop teeth 15) and of the second stop means (second set of teeth 21 and second stop tooth 22).

Moreover, the user, by twisting the supporting body 5 so as to turn it about the rotation axis 4a, can adjust the angular position of the working head 4 and orient it in the most appropriate manner according to the area of the head at which cutting is to be performed.

Such twisting action causes the retraction of the rod 43 into the sliding guide 44 in contrast with the action of the pusher spring 45 and the sliding of such rod on the portion of the path traced by the cylindrical cam 42 and comprised between the recesses 46, until the supporting body 5 reaches the selected angular position. At this point, by releasing the supporting body 5, the rod 43, pushed by the pusher spring 45, enters the corresponding recess 46, locking the supporting body 5.

The cutting blade assembly 6 and the motor assembly 7 rotate together with the supporting body 5 monolithically.

By acting on the button 31, the hair clipper 1 is operated at the selected operating speed.

The motor shaft 26 turns, turning the wheel 54.

The rotary motion of the wheel 54 is converted into a reciprocating rectilinear motion of the cutting blade 52 along the cutting direction H by way of the combination of the guiding of the motion of the eccentric pivot 55 along the slot 56 and of the guiding of the motion of the movable support 51 in a direction which is parallel to the cutting direction H.

The cutting blade 52 thus cuts the hair gathered by the comb element 8.

In practice it has been found that the described hair clipper according to the invention achieves the proposed aim and objects.

The hair clipper according to the invention can in fact be used easily by the individual user without the intervention of third parties.

The shape of the hair clipper according to the invention makes it particularly easy to grip and handle on the part of the user, who can thus cut his own hair.

The hair clipper according to the invention allows to adjust the cutting length by changing the relative position of the comb element with respect to the supporting body simply and easily.

The position of the comb element is ensured by the provided double stop system.

By way of the rotation, in one or both directions and through an extent which can even be a round angle, of the working head of the hair clipper according to the invention, it is further possible to change the orientation of the blade assembly as a function of the area where hair is to be cut.

The invention thus conceived is susceptible of numerous modifications and variations, all of which are within the scope of the appended claims.

All the details may further be replaced with other technically equivalent ones.

In practice, the materials used, as well as the shapes and dimensions, may be any according to requirements without thereby abandoning the scope of the protection of the appended claims.

The disclosures in Italian Patent Application No. MI2007A000304 from which this application claims priority are incorporated herein by reference.

Where technical features mentioned in any claim are followed by reference signs, those reference signs have been included for the sole purpose of increasing the intelligibility of the claims and accordingly, such reference signs do not have any limiting effect on the interpretation of each element identified by way of example by such reference signs.

1-19. (canceled)

20. A manually-operated hair clipper, comprising:
a substantially elongated enclosure, which defines at one end a handle and is provided, at the opposite end, with a working head, which comprises a body for supporting a cutting blade assembly and a motor assembly, means being provided for transmitting motion from said motor assembly to said cutting blade assembly,
at least one comb element, which is associated with said supporting body so that it can slide along a direction for approach and spacing with respect to said cutting blade assembly in order to adjust the cutting length, and
at least first means for stopping said comb element with respect to said supporting body.

21. The hair clipper according to claim 20, comprising second means for stopping said comb element with respect to said supporting body which are separate from said first stop means.

22. The hair clipper according to claim 21, wherein at least one of said first and second stop means is of the ratchet type.

23. The hair clipper according to claim 22, wherein said first stop means are of the ratchet type and comprise at least one first set of teeth, which is defined on the outer lateral surface of said supporting body and extends parallel to said approach and spacing direction, at least one corresponding first stop tooth, which is associated with said comb element so that it can move along a direction which is substantially perpendicular to said first set of teeth between an engagement configuration, in which said first stop tooth engages said first set of teeth to lock the sliding of said comb element, and a release configuration, in which said first stop tooth disengages from said first set of teeth to release the sliding of said comb element, and elastic pusher means which act between said first stop tooth and said comb element and are adapted to keep said first stop tooth in said engagement configuration.

24. The hair clipper according to claim 23, wherein said first stop tooth is defined at the end of a tab which protrudes from a button which is guided so that it can slide along said substantially perpendicular direction in a seat which is formed in said comb element, said elastic pusher means being interposed between the bottom of said seat and said button.

25. The hair clipper according to claim 23, wherein said first stop means comprise two of said first sets of teeth and of said corresponding first stop teeth, which are arranged symmetrically with respect to the longitudinal axis of said supporting body.

26. The hair clipper according to claim 25, wherein said second stop means are of the ratchet type and comprise at least one second set of teeth which is defined in said comb element and extends parallel to said approach and spacing direction, at least one corresponding second stop tooth which is associated with said supporting body so that it can move between an engagement configuration, in which said second stop tooth engages said second set of teeth to lock the sliding of said comb element, and a release configuration, in which said second stop tooth disengages from said second set of teeth to release the sliding of said comb element, second elastic means being provided which act on said second stop tooth to keep it in said engagement configuration.

27. The hair clipper according to claim 26, wherein said second elastic means comprise an elastically flexible tab in which one end is associated with said supporting body and the opposite end protrudes with said second stop tooth.

28. The hair clipper according to claim 26, wherein said first set of teeth and said second set of teeth have the same pitch and are arranged so that their teeth are mutually aligned.

29. The hair clipper according to claim 20, wherein said working head is associated with said enclosure so that it can rotate about a substantially longitudinal rotation axis through a round angle in both directions of rotation, means being provided for locking said working head in preset angular positions.

30. The hair clipper according to claim 29, wherein said motor assembly comprises an electric motor which is accommodated in a tubular support and protrudes, at one end, with a motor shaft and is associated, at an opposite end, with a connection to an electrical circuit, said tubular support being coupled with a rotary coupling to an end of said enclosure and being rigidly associated with said supporting body, said supporting body, said motor assembly and said cutting blade assembly rotating rigidly together.

31. The hair clipper according to claim 30, wherein said rotation axis is defined by an axis of said motor shaft.

32. The hair clipper according to claim 29, wherein said rotary coupling comprises a cylindrical bush, which surrounds externally said tubular support with the interposition of a pair of sealing rings, and a corresponding seat for accommodating said bush which is defined at the end of said enclosure, means being provided for connecting said bush and/or said tubular support to said seat which are adapted to prevent a relative axial sliding of said bush and/or of said tubular support with respect to said seat.

33. The hair clipper according to claim 30, wherein said locking means comprise a spring-loaded cam mechanism which is defined between a base of said tubular support which is directed toward said enclosure and said enclosure.

34. The hair clipper according to claim 33, wherein said spring-loaded cam mechanism comprises a cylindrical cam, which is defined on said base of the tubular support and is substantially concentric with respect to said rotation axis, a rod which is associated with said enclosure so that it can move with a reciprocating rectilinear motion along a direction which is substantially parallel to said rotation axis and in contrast with elastic pusher means, at least one recess for stopping said rod being formed along said cam.

35. The hair clipper according to claim 34, wherein said cam comprises a plurality of said recesses, which are mutually spaced with a constant angular pitch.

36. The hair clipper according to claim 20, wherein said blade assembly comprises at least one fixed blade and at least one cutting blade which can move with respect to said fixed blade with a reciprocating rectilinear motion along a cutting direction and is associated with said motion transmission means, said blades being parallel to a plane which is inclined with respect to a longitudinal axis of said supporting body, with respective cutting profiles directed toward the outside of said working head.

37. The hair clipper according to claim 36, wherein said blade assembly comprises a fixed support, which is coupled to said supporting body and on which said fixed blade is mounted, a movable support which is guided with a reciprocating rectilinear motion along said cutting direction on said fixed support and on which said cutting blade is mounted, and presser means which are adapted to press said fixed blade and said cutting blade against each other, a bracket for supporting said blade assembly being provided and being anchored to said supporting body.

38. The hair clipper according to claim 36, wherein said transmission means comprise a wheel which is keyed onto said motor shaft and is provided with an eccentric pivot which engages in a slot defined in said movable support.
